(19) United States
(12) Patent Application Publication
(10) Pub. No.: US 2021/0152459 A1
(43) Pub. Date: May 20, 2021

(54) SYSTEM AND METHOD FOR SHARING DATA AMONG A PLURALITY OF BLOCK CHAIN NETWORKS

(71) Applicant: MARKANY INC., Seoul (KR)

(72) Inventors: Kyung Jun Park, Seoul (KR); Hong Joon Ha, Seoul (KR); Dong Hwan Shin, Seoul (KR)

(21) Appl. No.: 16/951,840

(22) Filed: Nov. 18, 2020

(30) Foreign Application Priority Data
Nov. 19, 2019 (KR) 10-2019-0148338

(51) Int. Cl. H04L 12/751; H04L 9/32; H04L 12/741

(52) U.S. Cl. CPC H04L 45/02; H04L 9/3236; H04L 2209/38; H04L 45/54; H04L 9/3247

(57) ABSTRACT

Systems and methods for sharing data among a plurality of block chain networks are disclosed.

STATEMENT REGARDING GOVERNMENT SPONSORED RESEARCH

This work was supported by Institute of Information & communications Technology Planning & Evaluation (IITP) grant funded by the Korea government (MSIT) [2018-0-00365, Development of on-off hybrid blockchain technology for real-time large-scale data distribution].

### TECHNICAL FIELD

The present invention relates to a system and method for sharing data among heterogeneous block chain networks.

### BACKGROUND

A block chain refers to a distribution ledger technology that shares transactional details among participants of a block chain network by recording them in a ledger. The sharing of transactional information (data) among the members of the block chain network can be easily verified through the distributed ledger, but it is not easy to share the data among heterogeneous block chain networks.

Conventionally, in order to share data among heterogeneous block chain networks, a separate block chain network (for example, a side chain) was used. It is because the block chain networks participating in data sharing cannot trust each other. However, in that case, an additional block chain network is necessary, and thus it was not efficient in the aspect of the cost and process.

Moreover, conventionally, a method that each of a plurality of heterogeneous block chain networks records transactional information was used. However, in this case, since the same operation must be executed redundantly, it was also not efficient in the aspect of process.

### SUMMARY

The present invention has the task of solving the problems as above in data sharing among heterogeneous block chain networks.

According to one embodiment of the present invention for achieving the technical tasks mentioned above, a system for sharing data among a plurality of block chain networks comprises a first router comprising a first routing table and connected to a first block chain network; a second router comprising a second routing table and connected to a second block chain network; a participation request reception unit for receiving a participation request for sharing data with the first block chain network from the second block chain network; an approval reception unit for receiving an approval message that approves the participation request from the first block chain network, when the first block chain network approves the participation request, and a routing table management unit for creating an update message based on the participation request and the approval message and for transmitting the update message to the first router and the second router, when the approval reception unit receives the approval message from the first block chain network, wherein the first router and the second router transmits and receives data with each other, and the first router updates the first routing table based on the update message, and converts the data received from the second router into the form of the first block chain network based on the updated first routing table, and the second router updates the second routing table based on the update message, and converts the data received from the first router into the form of the second block chain network based on the updated second routing table.

The participation request may comprise at least any one among the form of the second block chain network, the network ID of the second router, the network address of the second router, the certificate of the second router, and the channel name of the second router.

The approval message may further comprise at least any one among the form of the first block chain network, the network ID of the first router, the network address of the first router, the certificate of the first router, and the channel name of the first router.

The routing table management unit may, when it receives a cessation request for ceasing the participation for sharing data from the second block chain network, creates a deletion message based on the cessation request, and transmits the deletion message to the first router and the second router, wherein the first router updates the updated first routing table based on the deletion message, and the second router updates the updated second routing table based on the deletion message.

The first router and the second router transmit and receive meta data with each other, and the meta data may comprise at least any one among information of a transmission side router, information of a reception side router, information of a transmission side block chain network, and information of a reception side block chain network.

According to another embodiment of the present invention, a method for sharing data among a plurality of block chain networks by the system for sharing data comprises a step of the participation request reception unit receiving a participation request for sharing data with the first block chain network from the second block chain network; a step of the approval reception unit receiving an approval message that approves the participation request from the first block chain network, when the first block chain network approves the participation request; a step of the routing table management unit creating an update message based on the participation request and the approval message when the approval reception unit receives the approval message from the first block chain network, a step of the routing table management unit transmitting the update message to the first router and the second router; and a step of the first router updating the first routing table based on the update message and converting the data received from the second router into the form of the first block chain network based on the updated first routing table, and the second router updating the second routing table based on the update message and converting the data received from the first router into the form of the second block chain network based on the updated second routing table.

According to one embodiment, the method may further comprise, a step of the routing table management unit receiving a cessation request for ceasing the participation for sharing data from the second block chain network; a step of the routing table management unit creating a deletion message based on the cessation request; a step of the routing table management unit transmitting the deletion message to the first router and the second router; and a step of the first router updating the updated first routing table based on the deletion message, and the second router updating the updated second routing table based on the deletion message.

As to the method for sharing data, the participation request may comprise at least any one among the form of the second block chain network, the network ID of the second router, the network address of the second router, the certificate of the second router, and the channel name of the second router.

Moreover, the approval message may further comprise at least any one among the form of the first block chain network, the network ID of the first router, the network address of the first router, the certificate of the first router, and the channel name of the first router.

Moreover, the first router and the second router transmit and receive meta data with each other, and the meta data may comprise at least any one among information of a transmission side router, information of a reception side router, information of a transmission side block chain network, and information of a reception side block chain network.

A computer readable storage medium recording a program for executing the method according to another embodiment of the present invention.

According to the present invention above, without a separate block chain network, sharing of data among heterogeneous block chain networks can be easily and efficiently done.

### BRIEF DESCRIPTION OF THE DRAWINGS

FIG. 1 is a drawing showing one embodiment of a system for sharing data.

FIG. 2 is a drawing showing one embodiment of an update message.

FIG. 3 is a drawing showing one embodiment of a form of a request for transmission of data.

FIG. 4 is a drawing showing one embodiment of a form of data exchange between routers.

FIG. 5 is a drawing showing one embodiment of a flowchart for sharing data among heterogeneous block chain networks.

### DETAILED DESCRIPTION

Hereinafter, preferable embodiments of the present invention will be explained in more detail with reference to the attached drawings, as follows. The advantages and features of the present invention, and the method for achieving those will be clear with reference to the examples to be explained hereinafter in detail together with the drawings attached. However, the embodiments of the present invention can be carried out in various forms and the present invention shall not be construed as being limited to the embodiments described in this text. The present embodiments are provided for the full disclosure of the present invention, for a skilled person in the art to fully understand the scope of the invention, and the present invention shall be determined by the scope of the claims. Throughout the specification, the identical reference numerals refer to identical features.

Unless defined otherwise, all terms used here, including the technical or scientific terms, mean the same as understood by a skilled person in the art to which the present invention pertains. Generally used terms, such as terms defined in a dictionary, shall be construed as having the same meaning in the context of the related technology, and unless otherwise defined explicitly in the present application, they shall not be construed as having ideal or excessively formal meaning.

The terminology used in the present application is used for the purposes of explaining a specific embodiment only, and it is not intended to limit the present invention. Singular expressions shall include the plural expressions unless expressly meant otherwise in context. In the present application, it shall be understood that the terms such as “comprise” or “have” etc., are intended to indicate the presence of the described feature, number, step, action, component, part or a combination thereof, and do not exclude the presence or possibility of addition of one or more of other features or numbers, steps, actions, components, parts or combinations thereof.

Unless defined otherwise in the present specification, “connected” or “linked” may include the description that one element/feature is directly connected or linked to another element/feature, or indirectly connected or linked with another element/feature in between, and does not essentially mean only the description that an element/feature is immediately connected or linked. Accordingly, the various mimetic diagrams shown in the drawings show the exemplary arrays of elements and components, but additional arbitrary elements, devices, features or components may exist in actual worked form (assuming that the function of elements shown are not adversely affected).

Moreover, in the present specification, “transmitting” or “receiving” may include, not only directly transmitting or receiving information between the transmitter and the receiver, but also, unless mentioned otherwise, transmitting or receiving information with another entity in between.

Moreover, unless defined otherwise in the present specification, expressions such as “a first,” “a second” and “a third” are merely used as terms to distinguish objects that can be referred to differently from each other for explanation of the invention, and are not essentially stipulating the order. Moreover, even if objects are referred to by categorization of “a first” and “a second,” they can be identical depending on the description of the object referred.

In the present invention, a block chain may be a public block chain, a private block chain, or a consortium block chain, etc. A block chain according to one embodiment of the present invention may have the characteristics explained below, but is not limited thereto, and a known block chain may be used.

According to one embodiment, each of the blocks constituting the block chain of the present invention is linked in a form of a Hash Chain. That is, nth block stores a hash value of n-1th block. Accordingly, a change in information of any one block leads to a change in the hash value of the corresponding block that is calculated from the corresponding block, and because this leads to a change in description of the next block, this essentially leads to a change in information of all blocks from the corresponding block and thereafter. Here, the hash value can be calculated by a hash function converting data of any size into data having a predetermined size.

In the present invention, a block chain may be implemented in a known block chain network other than explained above, and it may be an external network separate from a system 100 for sharing data, but may be implemented in a manner of sharing at least some nodes or devices with the system 100 for sharing data as necessary.

Hereinafter, with reference to the drawings, a system for sharing data according to embodiments of the present invention and a method thereof are explained.

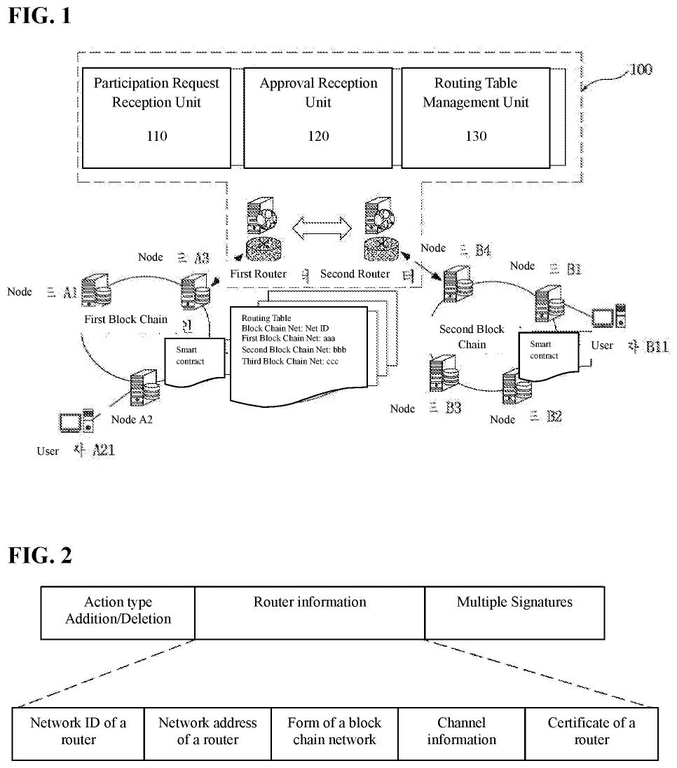

In FIG. 1, a system for sharing data according to one embodiment of the present invention is shown. According to one embodiment of the present invention, a system 100 for sharing data among a plurality of block chain networks comprises a first router comprising a first routing table and connected to a first block chain network; a second router comprising a second routing table and connected to a second block chain network; a participation request reception unit 110 for receiving a participation request for sharing data with the first block chain network from the second block chain network; an approval reception unit 120 for receiving an approval message that approves the participation request from the first block chain network, when the first block chain network approves the participation request, and a routing table management unit 130 for creating an update message based on the participation request and the approval message and for transmitting the update message to the first router and the second router, when the approval reception unit receives the approval message from the first block chain network, wherein the first router and the second router transmits and receives data with each other, and the first router updates the first routing table based on the update message, and converts the data received from the second router into the form of the first block chain network based on the updated first routing table, and the second router updates the second routing table based on the update message, and converts the data received from the first router into the form of the second block chain network based on the updated second routing table.

A first router is connected to a first block chain network, and comprises a first routing table. At this time, as in FIG. 1, a first router may be connected to one node (A3) constituting a first block chain network, as a separate node distinguished from nodes (A1, A2, A3) constituting a first block chain network. Alternatively, a first router can be one node constituting a first block chain network.

A second router is connected to a second block chain network, and comprises a second routing table. At this time, as in FIG. 1, a second router may be connected to one node (B4) constituting a second block chain network, as a separate node distinguished from nodes (B1, B2, B3, B4) constituting a second block chain network. Alternatively, a second router can be one node constituting a second block chain network.

FIG. 1 discloses only two block chain networks, but there is no restriction as to the number of block chain networks, and there is no restriction as to the number of routers. For example, data sharing can be made among three routers.

A routing table is a table used in routing, and may comprise information for a router participating in data sharing and information for a block chain network corresponding to each router. For example, the routing table may comprise information such as the identification of each router, the form of each block chain network, the ID of each block chain network and the channel name of each block chain network.

Each of routers has a routing table, and the routing table which a first router has is referred to as a first router, and the routing table which a second router has is referred to as a second router.

The form of a first block chain network and the form of a second block chain network may be different from each other. At this time, the two block chain networks are called a heterogeneous block chain network. As forms of a block chain network, representatively, there are Bitcoin, Etherium, Ripple, Eos, Tron, Ada and Hyperledger, etc.

A participation request reception unit 110 receives a participation request for sharing data from a block chain network which wishes to participate in data sharing. In one embodiment, for a second block chain network to share data with a first block chain network, a participation request reception unit 110 may receive a participation request from a second block chain network. In one embodiment, a node constituting a second block chain network may transmit a participation request to the participation request reception unit 110, and at this time, it may transmit the participation request through a second router.

At this time, the participation request may comprise at least any one among the form of the block chain network which wishes to participate in data sharing, the network ID of the router corresponding to the block chain network which wishes to participate in data sharing, the network address, the certificate and the channel name. As explained above, where a second block chain network wishes to share data with a first block chain network, the participation request which the second block chain network transmits to the participation request reception unit 110 may comprise at least one among the form of the second block chain network, the network ID of the second router, the network address of the second router, the certificate of the second router and the channel name of the second router.

An approval receipt unit 120 receives an approval message approving the participation request from the entity with whom to share data. For example, for a second block chain network to share data with a first block chain network, the second block chain network transmits a participation request to a participation request reception unit 110, and then, if the participation request reception unit 110 informs the first block chain network that the participation request has been transmitted, then the first block chain network may transmit an approval message approving the participation request to an approval reception unit 120. If a block chain network (the first block chain network in the example) with whom to share data refuses to approve the participation request, the participation of a block chain network (the second block chain network in the example) to participate in data sharing can be refused. At this time, after the participation request reception unit 110 receives the participation request, if a block chain network with whom to share data does not transmit the approval message to an approval reception unit 120 within predetermined time, then the block chain network with whom to share data may be deemed to have refused the participation. Alternatively, the block chain network with whom to share data may also transmit a refusal message clearly indicating intention of refusal to the approval reception unit 120.

In the example, the entity with whom to share data was one block chain network, but it may be a plurality of block chain networks. If, a first block chain network and a third block chain network have already formed a data sharing relation, and a second block chain network wishes to participate in the data sharing, the approval reception unit 120 may receive an approval message from the first block chain network and the third block chain network. At this time, if any one of the block chain networks with whom to share data refuses the approval of data sharing, the participation of the block chain network that wishes to participate in data sharing may be refused.

The approval message may be in various forms such as an electronic signature, a certificate, a signal, a code, or a text, etc. and is not restricted to any one of the above. At this time, the approval message may further comprise at least any one among the form of a block chain network with whom to share data, the network ID of the router corresponding to the block chain network with whom to share data, the network address, the certificate and the channel name. As explained above, for a second block chain network to share data with a first block chain network, an approval message which the first block chain network transmits to an approval reception unit 120 may further comprise at least any one among the form of the first block chain network, the network ID of the first router, the network address of the first router, the certificate of the first router, and the channel name of the first router.

When an approval reception unit 120 receives an approval message from a block chain network participating in data sharing, a routing table management unit 130 may create an update message based on the participation request and the approval message. As in FIG. 2, the update message may comprise router information, electronic signature, etc. At this time, the electronic signature included in the update message may be based on the approval message. For example, where the approval message is in the form of an electronic signature, the approval message may constitute a part of the update message. The router information may be based on the participation request. For example, the router information can be constituted with the form of a block chain network which wishes to participate in data sharing, the network ID of the router corresponding to a block chain network which wishes to participate in data sharing, the network address, the certificate, or the channel name, etc., which the participation request comprises. The routing table management unit 130 creates the update message, and then transmits the update message to the routers participating in data sharing thereafter. For example, if a second block chain network wishes to share data with a first block chain network, and the data sharing is approved by the first block chain network, then a first router and a second router are routers participating in the data sharing, and thus the routing table management unit 130 transmits the update message to the first router and the second router.

When one block chain network wishes to transmit data to a block chain network with a different form, data can be transmitted through routers. At this time, each of the routers has a routing table, and the routing table is updated using the update message. For example, where a second block chain network wishes to share data with a first block chain network, if the update message describes that the form of the second block chain network is Etherium, a first router may include in a first routing table information such as that “a second router participates in data sharing” and that “the form of a second block chain is Etherium.” Moreover, a second router may reflect in a second routing table a message that “it shares data with a first router.” Thereafter, the routers may change the data received from another router to suit the form of the receiving side block chain network using an updated routing table.

Meanwhile, the participation in data sharing may be ceased. If a second block chain network wishes to cease the participation in data sharing, it may transmit a cessation request for ceasing the participation in data sharing to the routing table management unit 130. At this time, the second block chain network may transmit the cessation request through a second router. Thereafter, if the routing table management unit 130 receives the cessation request, the routing table management unit 130 may create a deletion message based on the cessation request. At this time, the deletion message may be almost similar to the update message in terms of form and content. In FIG. 2, if an action type is “addition,” the corresponding message can be referred to as an update message, and if an action type is “deletion,” the corresponding message can be referred to as a deletion message. Thereafter, the routing table management unit 130 transmits the deletion message to a first router and a second router, and the first router and the second router may update a first routing table and a second routing table based on the deletion message, respectively. Specifically, in the example, the first router may delete the information regarding the second router and the second block chain network from the first routing table. Moreover, the second router reflects in a second routing table a message that data is no longer shared with the first router and the first block chain network, and may delete the information regarding the first router and the first block chain network from the second routing table.

Hereinafter, the overall process of a method for sharing data among heterogeneous block chain networks according to one embodiment is specifically explained.

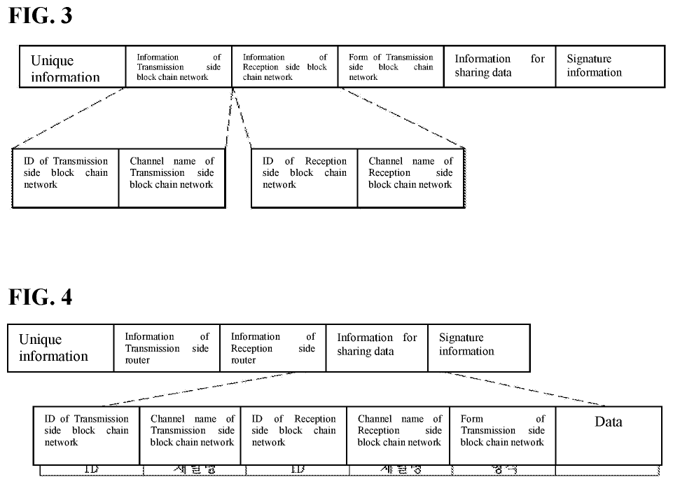

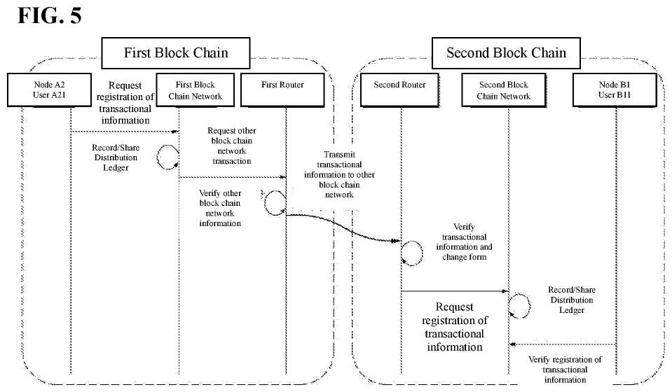

In review of the examples of FIG. 1 and FIG. 5, user A21 is linked to a node A2 constituting a first block chain network, user B11 is linked to a node B1 constituting a second block chain network, and user A21 wishes to have a transaction with user B11. Here, note A2 records transaction information on a distribution ledger and then, sends a transmission request to the first router to transmit the transaction information to a second block chain network to which user B11 is connected. One embodiment of the form of the transmission request is shown in FIG. 3. According to one embodiment, the transmission request may comprise unique information, information of a transmission side block chain network, information of a reception side block chain network, information for sharing data, or signature information. At this time, the unique information refers to the ID No. of the transmission request, and the information of the transmission side block chain network may comprise an ID of a transmission side block chain network, a channel name of a transmission side block chain network and a form of a transmission side block chain network, and the information of the reception side block chain network may comprise an ID of a reception side block chain network and a channel name of a reception side block chain network. Moreover, the information for sharing data refers to substantive content (for example, transaction time, transacted amount, etc.) of data to be shared, and the signature information may refer to the electronic signature of the node which transmitted the transmission request.

Thereafter, the first router may transmit transactional information to the second router using a predetermined form. At this time, one embodiment of the form of data exchange among routers is shown in FIG. 4. In the form of the data exchange, meta data such as unique information, information of a transmission side router, information of a reception side router, information for sharing data, or signature information may be included. At this time, unique information included in the form of the data exchange refers to the ID No. of the data exchange, and the information of the transmission side router may comprise a network ID of a transmission side router, a network address, a channel name or a certificate, and the information of the reception side router may comprise a network ID of a transmission side router, a network address, a channel name or a certificate. Moreover, the information for sharing data which the form of the data exchange comprises may be identical to the information for sharing data which the transmission request comprises, or may be a reconfiguration of the information for sharing data which the transmission request comprises. Moreover, the signature information which the form of the data exchange comprises may refer to the electronic signature of a router which requested the data exchange.

Thereafter, the second router changes the received transactional information into the form of a second block chain network. At this time, the second router may use the information which the form of the data exchange comprises, or may use a second routing table. For example, when the form of a first block chain network is Bitcoin, and the form of a second block chain network is Etherium, such information is described in the form of the data exchange or a second routing table. At this time, the second router may change data (transactional information) in the form of Bitcoin into the form of Etherium, by referring to the information described. Moreover, the second router may, by referring to both the information which the form of the data exchange comprises and the second routing table, verify whether the information which the form of the data exchange comprises matches the information which the second routing table comprises. Moreover, according to one embodiment, if the form of a transmission side block chain network and information of a transmission side router have already been described in the routing table, the form of the transmission request and the form of the data exchange reviewed above may be configured not to comprise the corresponding information.

Thereafter, the second router may connect to a node B4 constituting a second block chain network, and request a transaction with user B11 to a distribution ledger of a second block chain network. In addition, node B4 records the transaction request in the corresponding distribution ledger, and node B1 which is linked to user B11 may verify the transactional information with user B11.

The methods for sharing data may be executed on a computer readable storage medium recording a program.

As non-restrictive examples, computer readable media may include RAM, ROM, EEPROM, CD-ROM or other optical disk storage, magnetic disk storage or other magnetic storage devices, or any other storage medium that may be used in storing a desired program code means in a form of commands or data structures and may be accessed by a general or special-purpose computer, or a general or special-purpose processor. A disk or a disc includes, when used in the present invention, a compact disc (CD), a laser disc, an optical disc, a digital versatile disc (DVD), floppy disk and Blu-ray disk, and disks normally play data magnetically, but discs play data optically with a laser. The combinations of the aforementioned must also be included in the scope of a computer readable storage medium.

The examples of the present invention were explained with reference to the drawings attached above, but a skilled person in the art to which the present invention pertains will readily understand that the invention can be implemented in a different specific from without changing the technological idea or the essential feature. Accordingly, the examples described above shall be understood as exemplary in all aspects, and not restrictive.

### EXPLANATIONS OF REFERENCE NUMERALS

100: a system for sharing data
110: a participation request reception unit
120: an approval reception unit
130: a routing table management unit

What is claimed is:

1. A system for sharing data among a plurality of block chain networks, comprising:
a first router comprising a first routing table and connected to a first block chain network;
a second router comprising a second routing table and connected to a second block chain network;
a participation request reception unit for receiving a participation request for sharing data with the first block chain network from the second block chain network;
an approval reception unit for receiving an approval message that approves the participation request from the first block chain network, when the first block chain network approves the participation request, and
a routing table management unit for creating an update message based on the participation request and the approval message and for transmitting the update message to the first router and the second router, when the approval reception unit receives the approval message from the first block chain network,
wherein the first router and the second router transmits and receives data with each other, and
the first router updates the first routing table based on the update message, and converts the data received from the second router into the form of the first block chain network based on the updated first routing table, and
the second router updates the second routing table based on the update message, and converts the data received from the first router into the form of the second block chain network based on the updated second routing table.

2. The system for sharing data among a plurality of block chain networks according to claim 1, wherein
the participation request comprises at least any one among the form of the second block chain network, the network ID of the second router, the network address of the second router, the certificate of the second router, and the channel name of the second router.

3. The system for sharing data among a plurality of block chain networks according to claim 1, wherein
the approval message further comprises at least any one among the form of the first block chain network, the network ID of the first router, the network address of the first router, the certificate of the first router, and the channel name of the first router.

4. The system for sharing data among a plurality of block chain networks according to claim 1, wherein
the routing table management unit, when it receives a cessation request for ceasing the participation for sharing data from the second block chain network, creates a deletion message based on the cessation request, and transmits the deletion message to the first router and the second router, wherein
the first router updates the updated first routing table based on the deletion message, and
the second router updates the updated second routing table based on the deletion message.

5. The system for sharing data among a plurality of block chain networks according to claim 1, wherein
the first router and the second router transmit and receive meta data with each other, and
the meta data comprises at least any one among information of a transmission side router, information of a reception side router, information of a transmission side block chain network, and information of a reception side block chain network.

6. A method for sharing data among a plurality of block chain networks by a system for sharing data, wherein
the system for sharing data comprises:
a first router comprising a first routing table and connected to a first block chain network;
a second router comprising a second routing table and connected to a second block chain network;
a participation request reception unit;
an approval reception unit; and
a routing table management unit, wherein the first router and the second router transmit and receive data with each other, and
the method for sharing data comprises:
a step of the participation request reception unit receiving a participation request for sharing data with the first block chain network from the second block chain network;
a step of the approval reception unit receiving an approval message that approves the participation request from the first block chain network, when the first block chain network approves the participation request;
a step of the routing table management unit creating an update message based on the participation request and the approval message when the approval reception unit receives the approval message from the first block chain network,
a step of the routing table management unit transmitting the update message to the first router and the second router; and
a step of the first router updating the first routing table based on the update message and converting the data received from the second router into the form of the first block chain network based on the updated first routing table, and the second router updating the second routing table based on the update message and converting the data received from the first router into the form of the second block chain network based on the updated second routing table.

7. The method for sharing data among a plurality of block chain networks according to claim 6, wherein
the participation request comprises at least any one among the form of the second block chain network, the network ID of the second router, the network address of the second router, the certificate of the second router, and the channel name of the second router.

8. The method for sharing data among a plurality of block chain networks according to claim 6, wherein
the approval message further comprises at least any one among the form of the first block chain network, the network ID of the first router, the network address of the first router, the certificate of the first router, and the channel name of the first router.

9. The method for sharing data among a plurality of block chain networks according to claim 6, further comprising:
a step of the routing table management unit receiving a cessation request for ceasing the participation for sharing data from the second block chain network;
a step of the routing table management unit creating a deletion message based on the cessation request;
a step of the routing table management unit transmitting the deletion message to the first router and the second router; and
a step of the first router updating the updated first routing table based on the deletion message, and the second router updating the updated second routing table based on the deletion message.

10. The method for sharing data among a plurality of block chain networks according to claim 6, wherein
the first router and the second router transmit and receive meta data with each other, and
the meta data comprises at least any one among information of a transmission side router, information of a reception side router, information of a transmission side block chain network, and information of a reception side block chain network.

11. A computer readable storage medium recording a program for executing the method of claim 6.

12. A computer readable storage medium recording a program for executing the method of claim 7.

13. A computer readable storage medium recording a program for executing the method of claim 8.

14. A computer readable storage medium recording a program for executing the method of claim 9.

15. A computer readable storage medium recording a program for executing the method of claim 10.
